(19) United States
(12) Patent Application Publication
(10) Pub. No.: US 2026/0252002 A1
(43) Pub. Date: Aug. 27, 2026

(54) LEP PRINTING DEVICE BID ASSEMBLY CONSTANT CURRENT MODE

(71) Applicant: Hewlett-Packard Development Company, L.P., Spring, TX (US)

(72) Inventors: Eric G. NELSON, Boise, ID (US); Barry J. OLDFIELD, Boise, ID (US)

(73) Assignee: Hewlett-Packard Development Company, L.P., Spring, TX (US)

(21) Appl. No.: 18/855,927

(22) PCT Filed: Apr. 11, 2022
(86) PCT No.: PCT/US2022/024202

§ 371 Date: Oct. 10, 2024

(51) Int. Cl. G03G 15/10; G03G 15/00; G03G 15/06; G03G 15/11

(52) U.S. Cl. CPC G03G 15/105; G03G 15/065; G03G 15/11; G03G 15/5004; G03G 2215/0658

(57) ABSTRACT

A liquid electrophotography (LEP) printing device includes a binary ink developer (BID) assembly to receive ink from an ink supply. The BID assembly including a developer electrode, a developer roller, and a squeegee roller. The LEP printing device includes a photoconductive imaging cylinder to which the BID assembly is to transfer the ink in accordance with an electrostatic image on the imaging cylinder. The LEP printing device includes one or multiple power supplies to provide power to either or both of the developer electrode and the squeegee roller in a constant current mode.

### BACKGROUND

Printing devices, like printers, use various technologies to output printing fluid, including colorant such as toner or ink, onto media like paper. Electrophotography is a printing technique first employed by laser printers, in which toner is applied to a drum or other transfer member in accordance with an electrostatic image that has been formed on the drum, and then subsequently transferred to a medium. More recently, electrophotography has been leveraged for use with liquid ink, in a process referred to as liquid electrophotography (LEP). LEP technology can equal or exceed the print quality of existing offset lithographic and flexographic printing processes.

### BRIEF DESCRIPTION OF THE DRAWINGS

FIG. 1 is a diagram of an example liquid electrophotography (LEP) printing device.

FIG. 2 is a diagram of an example binary ink developer (BID) assembly for an LEP printing device.

FIG. 3 is a diagram of an example power supply for a BID assembly for an LEP printing device to operate a developer electrode and/or a squeegee roller of the BID assembly in a constant current mode.

FIG. 4 is a flowchart of an example method for operating a developer electrode and/or a squeegee roller of a BID assembly for an LEP printing device in a constant current mode.

### DETAILED DESCRIPTION

As noted in the background, liquid electrophotography (LEP) is a printing technology that employs liquid ink instead of (typically dry) toner as in laser printing and other existing electrophotography technologies. In an LEP printing device, electrically charged liquid ink is transferred to a roller assembly referred to as a binary ink developer (BID) assembly, which includes a developer roller and which increases the concentration of solids such as resin and pigments within the liquid ink. From the BID assembly, the ink is transferred to a photoconductive imaging cylinder, referred to as a print-imaging plate (PIP), in accordance with an electrostatic latent image on the cylinder. Unlike as in other electrophotography technologies, the ink is then transferred from the PIP to a heated blanket cylinder, or warming blanket, which evaporates carrier liquids and transforms the liquid ink into a hot melt, which is almost 100% solid, before the ink is finally transferred to media being advanced via an impression drum.

The liquid ink is charged prior to the BID assembly and the BID assembly increases the solid concentration of the ink. The PIP is also charged, but more so than the ink, and is selectively discharged in accordance with the image to be formed on a medium. The liquid ink is thus attracted to areas of the PIP that have been selectively discharged, while being repelled from those areas that have not. In this way, the liquid ink is transferred to the PIP in accordance with the image to be formed on a medium.

Within the BID assembly specifically, the liquid ink is first developed on a developer roller of the BID assembly via a developer electrode. This is achieved by setting a voltage bias between the developer electrode and the developer roller. The developed ink then further concentrated by a squeegee roller, both mechanically and electrostatically. The latter can similarly be achieved by a setting a voltage bias between the squeegee roller and the developer roller.

However, the developed ink layer tends to change in thickness over the course of a page. Specifically, the developed ink layer can increase over time and then drop back down as the voltages are cycled. The increase in thickness over time can vary with print substrate properties, ink properties, and other variables. The changes in the developed ink thickness result in color variations on the printed page.

Furthermore, when the BID assembly is engaged to the PIP to initiate printing, the resulting impact causes the gap between the developer electrode and the developer roller to change. This can result in a step change and/or a vibrational change in gap distance. Such gap changes result in electric field changes, which then result in changes in the thickness of the developed ink layer. As before, the end result is color variations on the printed page.

Techniques described herein ameliorate these issues, by addressing the root cause of developed ink thickness variations. In particular, the inventors have novelly discovered that ink development on the developer roller is highly correlated with current. Rather than the developer electrode (and/or the squeegee roller) being operated in a constant voltage mode, therefore the developer electrode (and/or the squeegee roller) are instead operated in a constant current mode.

Operation of the developer electrode and/or the squeegee roller in a constant current mode adjusts the electric field between the developer electrode and the developer roller and/or between the squeegee roller and the developer roller to maintain a more constant ink development rate. A more constant ink development rate in turn reduces if not eliminates the thickness variations in the developed ink on the developer roller. As such, image quality on the printed page is improved.

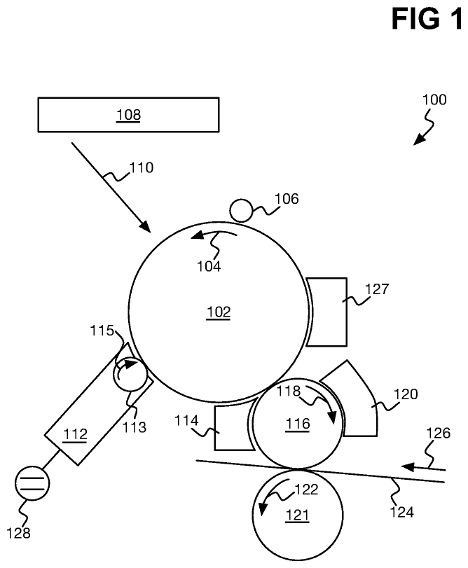

FIG. 1 shows an example LEP printing device 100. The printing device 100 includes a PIP 102, which is more generally a photoconductive imaging cylinder. The PIP 102 rotates counterclockwise as indicated by arrow 104. The PIP 102 rotates past a charge roller 106 of the printing device 100, which charges the PIP 102. A laser 108 or other discharge mechanism of the printing device 100 selectively discharges the PIP 102 via a laser beam 110 or other optical beam, in accordance with an image to be formed on a print medium like paper, as the PIP 102 rotates past the laser beam 110 and the laser beam 110 is normal to the PIP 102. Therefore, an electrostatic latent image is formed on the PIP 102.

The LEP printing device 100 includes a BID assembly 112 that is powered by one or multiple power supplies 128. There can be more than one BID assembly 112, rotationally arranged relative to the PIP 102 counterclockwise from the depicted BID assembly 112 in FIG. 1. Each BID assembly 112 corresponds to a different color or type of ink. The BID assembly 112 includes a developer roller 113 rotating clockwise as indicated by arrow 115 to transfer electrically charged liquid ink onto the PIP 102 in accordance with an electrostatic image on the PIP 102 by the laser beam 110 of the laser 108. That is, where the image is to be formed on a print medium, which is an image portion of the image, the ink is electrically attracted to the PIP 102, and is not electrically attracted to the PIP 102 where the image is not to be formed on the medium, which is a background portion of the image.

The PIP 102 rotates past a pre-transfer discharge unit 114 of the LEP printing device 100, which electrically discharges remaining charge corresponding to the background portion of the prior electrostatic image on the PIP 102. The printing device 100 includes a blanket 116, which is also referred to as a blanket cylinder and which may be a belt blanket, which rotates clockwise as indicated by the arrow 118. The blanket 116 rotates past a heating mechanism 120 that heats the blanket 116. The heated blanket 116 and the PIP 102 contact one another as they rotate, which transfers the ink from the PIP 102 to the heated blanket 116. The heated blanket 116 reduces the liquid content of the ink, rendering the ink as a sticky film on the blanket 116. The PIP 102 continues to rotate past a cleaning station 127, which removes any ink residue from the PIP 102 and prepares it for another rotation past the charge roller 106. The cleaning station 127 may include a wetting roller to wet the PIP 102, and a sponge and a wiper to then remove the wetted ink residue from the PIP 102, for instance.

The LEP printing device 100 includes an impression cylinder 121, or impression drum, which rotates counterclockwise as indicated by arrow 122. Rotation of the impression cylinder 121, together with rotation of the blanket 116, advances a print substrate 124, like paper, in the direction indicated by arrow 126. The film of ink is transferred from the blanket 116 onto the substrate 124 against the impression cylinder 121, as the substrate 124 advances between the impression cylinder 121 and the blanket 116.

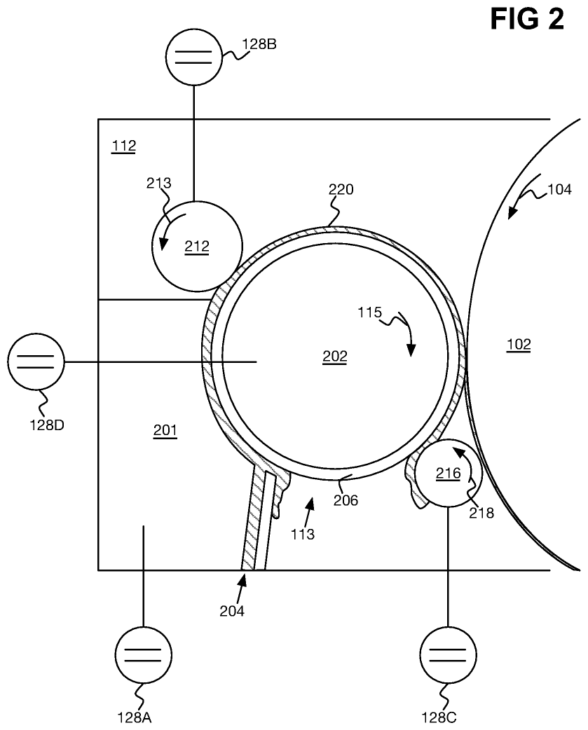

FIG. 2 shows the example BID assembly 112 of the LEP printing device 100. The developer roller 113 of the BID assembly 112 includes an exterior conductive or nonconductive coating 206 around a conductive metal core roller 202. The developer roller 113 rotates clockwise as indicated by arrow 115. Liquid ink 220 having a low percentage of solids, such as resins and pigments, is pumped within a channel 204 of the BID assembly 112. The liquid ink 220 can include charged ink particles and counter charges in the form of oppositely charged micelles. (It is noted that the thickness of the ink 220 is not drawn to scale in FIG. 2.) After the liquid ink 220 is pumped within the channel 204, the charged ink particles and oppositely charged micelles are separated due to an electric field between a developer electrode 201 and the developer roller 113. As the developer roller 113 rotates past the electrode 201, the exterior coating 206 thus receives charged ink 220. That is, the developer electrode 201 is said to plate, or develop, the charged ink 220 onto the coating 206. (Other of the ink 220, however, flows to the right, as shown in the figure.) The developer roller 113 continues to rotate towards a squeegee roller 212 of the BID assembly 112, which is in near contact with the coating 206, and which is rotating counterclockwise per arrow 213. The squeegee roller 212 may also be referred to as a squeeze roller.

After receiving the liquid ink 220 on the exterior coating 206, the developer roller 113 rotates past the squeegee roller 212. The squeegee roller 212 reduces a thickness of the liquid ink 220 on the coating 206, which reduces the liquid content of the ink. The squeegee roller 212 compacts the ink 220 both mechanically and electrostatically. (The thickness of the ink 220 after compaction by the squeegee roller 212 is shown as significantly thicker than in actuality for illustrative clarity.) The developer roller 113, with the reduced-thickness ink 220 on its exterior coating 206, continues to rotate past the PIP 102 of the LEP printing device 100, which is rotating counterclockwise per the arrow 104.

The ink 220 is thus transferred to image portions of an electrostatic image formed on the PIP 102, as described above in relation to FIG. 1. The ink 220 is not transferred to the PIP 102 at background portions of the image because there is more charge on the PIP 102 than on the developer roller 113, resulting in an electric field that directs ink away from the PIP 102. After transfer of the ink 220 from the exterior coating 206 to the PIP 102 in accordance with the electrostatic image on the PIP 102, the developer roller 113 rotates past a cleaner roller 216, which rotates counterclockwise per arrow 218, and which may also be referred to as a cleaning roller. The cleaner roller 216 removes (any) remaining ink 220 from the coating 206, preparing the developer roller 113 for another rotation.

The one or multiple power supplies 128 of FIG. 1 specifically include four power supplies 128A, 128B, 128C, and 128D in the example of FIG. 2. The power supply 128A provides power to the developer electrode 201 to create an electric field between the electrode 201 and the developer roller 113. The power supply 128B provides power to the squeegee roller 212 to create an electric field between the squeegee roller 212 and the developer roller 113. The power supply 128A may provide power to the developer electrode 201 in a constant current mode, and/or the power supply 128B may provide to the squeegee roller 212 in a constant current mode, to minimize variations in developed ink thickness on the developer roller 113.

Either the power supply 128A or the power supply 128B may instead operate in a constant voltage mode during printing. For example, if just the power supply 128A operates in a constant current mode during printing, then the power supply 128B operates in a constant voltage mode during printing. Similarly, if just the power supply 128B operates in a constant current mode during printing, then the power supply 128A operates in a constant voltage mode during printing. However, both the power supplies 128A and 128B may operate in a constant voltage mode during uniformity calibration, or other non-print situations.

The power supply 128C provides power to the cleaner roller 216 to create an electric field between the cleaner roller 216 and the developer roller 113. The power supply 128D provides power to the developer roller 113 to create an electric field between the developer roller 113 and the PIP 102.

The power to the developer roller 113 may also assist in creation of the electric field between the developer roller 113 and the developer electrode 201, the squeegee roller 212, and/or the cleaner roller 216. The power supplies 128C and 128D may provide power and operate in a constant voltage mode.

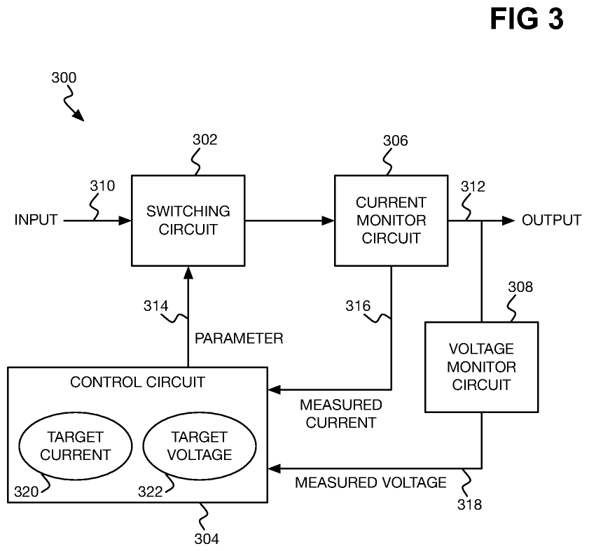

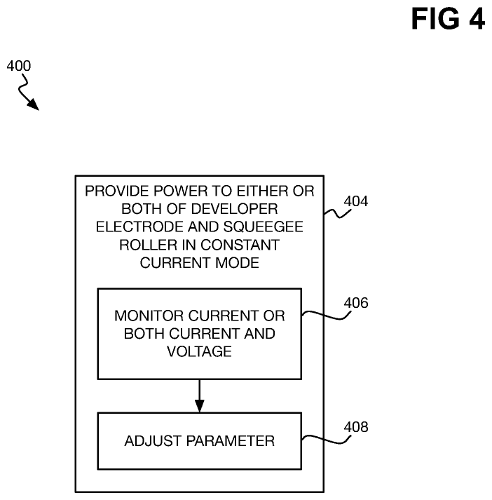

FIGS. 3 and 4 shows an example power supply 300. Either or both of the power supply 128A providing power to the developer electrode 201 and the power supply 128B providing power to the squeegee roller 212 can each be implemented as the power supply 300. The power supply 300 can include a switching circuit 302, a control circuit 304, a current monitor circuit 306, and a voltage monitor circuit 308. The switching circuit 302 receives an input 310 from an external power source, such as another power supply of the printing device 100 or a wall outlet, and provides an output 312 to the developer electrode 201 or the squeegee roller 212.

As one example, the switching circuit 302 may have a pulse-width modulated (PWM) duty cycle to control the voltage and current of the output 312 provided to the developer electrode 201 or the squeegee roller 212. The switching circuit 302 is controlled by a parameter 314 that governs providing of the output 312 in this respect, as is described in more detail below. The switching circuit 302 may be implemented via a collection of suitably connected transistors, resistors, inductors, and capacitors. The switching circuit 302 may be able to step the voltage of the input 310 up or down to realize the voltage of the output 312.

The control circuit 304 may be implemented as an application-specific integrated circuit (ASIC), microcontroller, or another type of integrated circuit. The control circuit 304 provides the parameter 314 to the switching circuit 302 to provide the output 312 to the developer electrode 201 or the squeegee roller 212 in a constant current mode or in a constant voltage mode. The control circuit 304 in this respect uses the measured current 316 and/or the measured voltage 318 of the output 312 as feedback to continually adjust the parameter 314 in a feedback loop.

The current monitor circuit 306 may be disposed in series between the switching circuit 302 and the developer electrode 201 or the squeegee roller 212. By comparison, the voltage monitor circuit 308 may be disposed in parallel with the switching circuit 302 and the developer electrode 201 or the squeegee roller 212. The current monitor circuit 306 measures the current of the provided output 312, and outputs the measured current 316 to the control circuit 304. The voltage monitor circuit 308 similarly measures the voltage of the provided output 312, and outputs the measured voltage 318 to the control circuit 304. The monitor circuits 306 and 308 may each be implemented as a collection of suitably connected transistors, resistors, inductors, capacitors, and operational amplifiers.

In one implementation, the parameter 314 governing providing of the output 312 to the developer electrode 201 or the squeegee roller 212 by the switching circuit 302 specifically governs providing of the current of the output 312. That is, the switching circuit 302 specifically adjusts current based on the parameter 314, in a single current loop. The control circuit 304 can therefore operate the developer electrode 201 or the squeegee roller 212 in a constant current mode using just the measured current 316 as feedback, without having to use the measured voltage 318. Specifically, the control circuit 304 adjusts the parameter 314 based on the variation between the measured current 316 and a target current 320 that is constant.

In this implementation, to instead operate the developer electrode 201 or the squeegee roller 212 in a constant voltage mode, the control circuit 304 uses both the measured current 316 and the measured voltage 318, via an inner current loop and an outer voltage loop. Specifically, the control circuit 304 adjusts the target current 320 needed to maintain a constant voltage, based on the variation between the measured voltage 318 and a target voltage 322 that is constant. The control circuit 304 then adjusts the parameter 314 based on the variation between the measured current 316 and the adjusted target current 320.

By comparison, in another implementation, the parameter 314 governing providing of the output 312 to the developer electrode 201 or the squeegee roller 212 by the switching circuit 302 specifically governs providing of the voltage of the output 312. That is, the switching circuit 302 specifically adjusts voltage based on the parameter 314, in a single voltage loop. The control circuit 304 can therefore operate the developer electrode 201 or the squeegee roller 212 in a constant voltage mode using just the measured voltage 318 as feedback, without having to use the measured current 316. Specifically, the control circuit 304 adjusts the parameter 314 based on the variation between the measured voltage 318 and a target voltage 322 that is constant.

In this implementation, to instead operate the developer electrode 201 or the squeegee roller 212 in a constant current mode, the control circuit 304 uses both the measured current 316 and the measured voltage 318, via an inner voltage loop and an outer current loop. Specifically, the control circuit 304 adjusts the target voltage 322 needed to maintain a constant current, based on the variation between the measured current 316 and a target current 320 that is constant. The control circuit then adjusts the parameter 314 based on the variation between the measured voltage 318 and the adjusted target voltage 322.

FIG. 4 shows an example method 400. The method 400 includes providing power from one or multiple power supplies 128 to either or both of the developer electrode 201 and the squeegee roller 212 of the BID assembly 112 in a constant current mode (404). For example, the method 400 can include monitoring either the current provided to the developer electrode 201 or the squeegee roller 212 or both the voltage and the current provided to the electrode 201 or the squeegee roller 212 (406).

The method 400 can include then adjusting a parameter 314 governing providing of the power from an external power source to the developer electrode 201 or the squeegee roller 212, based on the measured current or the measured current and the measured voltage, to maintain a constant current (408). As noted above, if the parameter 314 specifically governs providing of current, then just the measured current may be used as feedback for constant current mode operation, via a single current loop. By comparison, if the parameter 314 governs providing of voltage, then both the measured current and the measured voltage may be used as feedback for constant current mode operation, via an inner voltage loop and an outer current loop.

Techniques have been described for operating either or both of the developer electrode 201 and the squeegee roller 212 of the BID assembly 112 of an LEP printing device 100 in a constant current mode. Constant current mode operation in this respect reduces variation in the thickness of the developed ink on the developer roller 113. Such thickness variation reduction results in improved image quality, by improving color uniformity on the printed page.

We claim:

1. A liquid electrophotography (LEP) printing device comprising:
a binary ink developer (BID) assembly to receive ink from an ink supply, the BID assembly including a developer electrode, a developer roller, and a squeegee roller;
a photoconductive imaging cylinder to which the BID assembly is to transfer the ink in accordance with an electrostatic image on the imaging cylinder; and
one or multiple power supplies to provide power to either or both of the developer electrode and the squeegee roller in a constant current mode.

2. The LEP printing device of claim 1, wherein the power supplies are to provide the power to the developer electrode and not the squeegee roller in the constant current mode.

3. The LEP printing device of claim 1, wherein the power supplies are to provide the power to the squeegee roller and not the developer electrode in the constant current mode.

4. The LEP printing device of claim 1, wherein the power supplies are to provide the power to both the developer electrode and the squeegee roller in the constant current mode.

5. The LEP printing device of claim 4, wherein the power supplies comprise:
a first power supply to provide the power to the developer electrode in the constant current mode; and
a second power supply to provide the power to the squeegee roller in the constant current mode.

6. The LEP printing device of claim 1, wherein the power supplies are to provide the power to the developer roller in a constant voltage mode.

7. The LEP printing device of claim 6, wherein the BID assembly further comprises a cleaner roller, and the power supplies are to provide the power to the cleaner roller in the constant voltage mode.

8. The LEP printing device of claim 1, wherein the power supply comprises:
one or multiple current monitor circuits to measure a current provided to either or both of the developer electrode and the squeegee roller; and
a control circuit to, using the measured current as feedback, adjust a voltage provided to either or both of the developer electrode and the squeegee roller to provide a constant current to either or both of the developer electrode and the squeegee roller.

9. A power supply for a binary ink developer (BID) assembly of a liquid electrophotography (LEP) printing device, comprising:
a switching circuit to provide power to a developer electrode or a squeegee roller of the BID assembly of the LEP printing device; and
a control circuit to maintain providing of the power by the switching circuit to the developer electrode or the squeegee roller in a constant current mode.

10. The power supply of claim 9, further comprising:
a current monitor circuit to measure a current provided to the developer electrode,
wherein the control circuit is to adjust a parameter governing providing of the current by the switching circuit from an external power source to the developer electrode, based on the measured current, to maintain a constant current to the developer electrode.

11. The power supply of claim 9, further comprising:
a current monitor circuit to measure a current provided to the developer electrode; and
a voltage monitor circuit to measure a voltage provided to the developer electrode,
wherein the control circuit is to:
adjust a target voltage, based on the measured current, needed to maintain a constant current to the developer electrode;
adjust a parameter governing providing of the voltage by the switching circuit from an external power source to the developer electrode, based on the measured voltage, to provide the target voltage to the developer electrode.

12. The power supply of claim 9, further comprising:
a current monitor circuit to measure a current provided to the squeegee roller,
wherein the control circuit is to adjust a parameter governing providing of the current by the switching circuit from an external power source to the squeegee roller, based on the measured current, to maintain a constant current to the squeegee roller.

13. The power supply of claim 9, further comprising:
a current monitor circuit to measure a current provided to the squeegee roller; and
a voltage monitor circuit to measure a voltage provided to the squeegee roller,
wherein the control circuit is to:
adjust a target voltage, based on the measured current, needed to maintain a constant current to the squeegee roller;
adjust a parameter governing providing of the voltage by the switching circuit from an external power source to the squeegee roller, based on the measured voltage, to provide the target voltage to the squeegee roller.

14. A method comprising:
providing power from one or multiple power supplies to either or both of a developer electrode of a binary ink developer (BID) assembly of a liquid electrophotography (LEP) printing device and a squeegee roller of the BID assembly in a constant current mode.

15. The method of claim 14, wherein providing the power from the power supplies to either or both of the developer electrode and the squeegee roller in the constant current mode comprises:
monitoring a current provided to the developer electrode or the squeegee roller; and
adjusting a parameter governing providing of the power from an external power source to the developer electrode or the squeegee roller, based on the monitored current, to maintain a constant current.
